(19) United States
(12) Patent Application Publication
(10) Pub. No.: US 2012/0055931 A1
(43) Pub. Date: Mar. 8, 2012

(54) Technique for creating vacuum sealed packages

(75) Inventor: Anton Petrus Maria van Arendonk, Waterloo (CA)

(73) Assignee: Teledyne Dalsa, Inc., Waterloo (CA)

(21) Appl. No.: 13/199,352

(22) Filed: Aug. 26, 2011

Related U.S. Application Data
(60) Provisional application No. 61/402,904, filed on Sep. 7, 2010.

(51) Int. Cl. B65D 53/00; B23K 31/02; B23K 1/20

(52) U.S. Cl. 220/378; 228/203; 228/178

(57) ABSTRACT

A method of sealing a package includes plating a perimeter of a hole formed in a package and attaching a solder film to the plated perimeter, the solder film covering the hole. The method further includes assembling a device in the package and sealing the package to define an interior and an outside, the device being contained within the interior. Next, the method includes heating the assembled package in a vacuum oven to a predetermined temperature where the solder film bonds to the plated perimeter, evacuating the vacuum oven to form a vacuum until the solder film fractures as a gas contained in the interior escapes to the outside, and further heating the assembled package in the vacuum oven after the gas in the interior escapes to the outside and until the solder film re-melts and seals over the hole.

The priority of the Sep. 7, 2010 filing date of provisional application No. 61/402,904 is hereby claimed.

### BACKGROUND OF THE INVENTION

### Description of Related Art

In order to provide improved performance and/or achieve longer lifetime, many devices require or would benefit from vacuum packaging or alternatively would benefit from evacuating a cavity within the package and then back filling the cavity with dry nitrogen, carbon dioxide, a noble gas or other gas. Vacuum helps to reduce corrosion, and thereby increases the life time of components in the package. Components may include MEMs (Micro Electronic Machines or Micro Electronic Mechanical), and MEMs often have movable parts. Vacuum reduces air friction for the movable parts. Vacuum or dry gases improve performance of silicon parts since there is no moisture.

Known processes are labor intensive or they require some special feature. For example, a special feature might be the enclosure of a bolometer in an hermetically sealed glass tube through which a vacuum is drawn and the tube end heated to melt the glass and seal the vacuum. Such tubes usually limit miniaturization and cost reduction of the end product.

### SUMMARY OF THE INVENTION

Examples of the invention includes a method of sealing a package includes plating a perimeter of a hole formed in a package and attaching a solder film to the plated perimeter, the solder film covering the hole. The method further includes assembling a device in the package and sealing the package to define an interior and an outside, the device being contained within the interior. Next, the method includes heating the assembled package in a vacuum oven to a predetermined temperature where the solder film bonds to the plated perimeter, evacuating the vacuum oven to form a vacuum until the solder film fractures as a gas contained in the interior escapes to the outside, and further heating the assembled package in the vacuum oven after the gas in the interior escapes to the outside and until the solder film re-melts and seals over the hole.

A further example of the invention includes a method of sealing a package includes plating a perimeter of a hole formed in a package and attaching a solder film to the plated perimeter, the solder film covering the hole. The method further includes assembling a device in the package and sealing the package to define an interior and an outside, the device being contained within the interior. Next, the method includes heating the assembled package in a vacuum oven to a predetermined temperature where the solder film bonds to the plated perimeter, evacuating the vacuum oven to form a vacuum, puncturing the solder film with a needle so that a gas contained in the interior escapes to the outside, and further heating the assembled package in the vacuum oven after the gas in the interior escapes to the outside and until the solder film re-melts and seals over the hole.

In another example, a packaged device includes a package having a hole formed therein, a perimeter of the hole being plated. This packaged device further includes a solder film attached to the plated perimeter of the hole, a device assembled within the package, and a lid attached to the package. The package, the lid and the solder film cooperate to enclose an evacuated vacuum chamber in which the device is contained.

### BRIEF DESCRIPTION OF DRAWINGS

The invention will be described in detail in the following description of preferred embodiments with reference to the following figures.

FIG. 1A is a schematic cross-section view of a package to be sealed.

FIG. 1B is a schematic plan view of a package to be sealed.

FIG. 2 is a schematic section of batch fixture in a vacuum oven.

FIG. 3 is a flow chart of one method of sealing a package.

FIG. 4 is a flow chart of another method of sealing a package.

FIG. 5 is a schematic cross-section view of an alternative package seal.

### DETAILED DESCRIPTION OF PREFERRED EMBODIMENTS

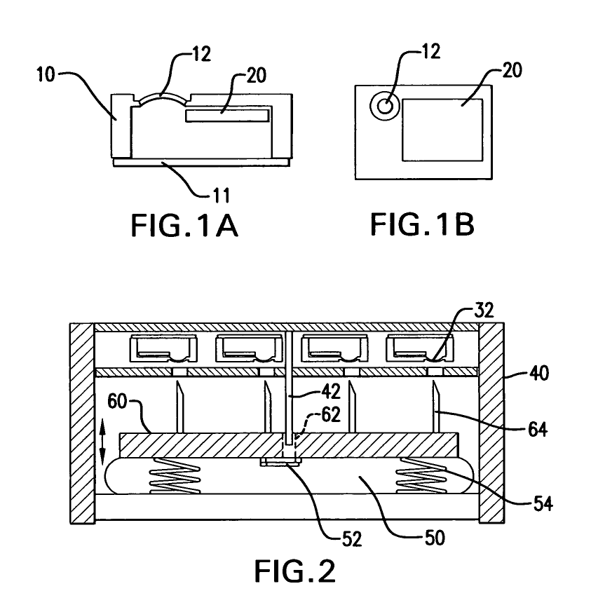

An initial package 10, whether it be metal, ceramic or plastic, is provided with a hole. The perimeter of the hole is then plated so that solder 12 can easily adhere to the perimeter of the hole and the solder covers over this hole. Solder is then melted so as to attach to the plated perimeter of the hole and cover the hole. See FIGS. 1A and 1B.

As depicted in FIGS. 1A and 1B, a device 20, such as a semiconductor die, is attached to package 10. The device could also be a MEMs device or a bolometer. After the device is attached, the assembly process of the packaged device continues with wire bonding between device pads and package pins (not shown for clarity), and then lid 11 is sealed to the package.

Then, the packages are placed in vacuum oven 40 (see FIG. 2). The temperature is raised to a certain predefined temperature, and at that point, the vacuum will be turned on. Because of the softened solder, the hole design and the pressure difference between interior of the package and the vacuum of the vacuum oven, the solder cracks at the hole sufficiently to establish a vacuum condition inside of the package (see FIGS. 1A and 1B).

After a while the vacuum is stabilized in the interior of the package and any desorption of gasses from the interior of the package is drawn out by the vacuum. Then, the temperature of the vacuum oven is increases further until the solder sufficiently liquefies and re-melts. Because of the solder surface tension, the hole is closed automatically.

In an alternative depicted in FIG. 2, a plurality of packages 32 are placed in vacuum oven 40 and registered into respective predetermined positions. Plate 60 is mounted on windbag 50, and tiny needles 64 puncture the softened solder in packages 32. After the temperature in the vacuum oven is raised to the certain predefined temperature as described above or even a slightly different temperature and the vacuum is at least partially turned on. The rising temperature and increasing vacuum permits springs 54 to push plate 60 toward packages 32 until the tiny needles 64 puncture the softened solder film to more precisely select the suction path though the solder film as located by the needles through which the package is evacuated of gasses to establish a vacuum in the package.

When placed in a vacuum oven, windbag 50 (see FIG. 2) will increase in volume as more vacuum is applied and there will be a resulting movement of the needles that punch through the solder film. After a certain movement has been reached, piston 42, similar to a pushrod, will slide through hole 62 in plate 60 to push open valve 52 at the windbag (see FIG. 2). After valve 52 opens and air or other gas escapes from windbag 50 and is drawn off by the vacuum of the vacuum oven, springs 54 in the windbag pull on that plate 60 to ensure that needles 62 retract from the solder film, thus ensuring a small opening in the solder film. In this way, gasses in the package are evacuated at lesser heated temperatures relative to the melting point of solder than would be required if the solder were required to be heated to the point of fracturing or popping. Due to the vacuum prior to re-melting of the solder, the next heating re-melts the solder and re-seals the solder over the hole.

In an alternative, piston 42 in FIG. 2 might alternatively depict an external tube sealed within hole 62 to plate 60, but without valve 52, where the tube 42 is used to directly connect to the windbag to a vacuum and air source to precisely control the pressure inside of the windbag.

Both sealing principles are based on the fact that, when the solder has been fractured or punctured, there will be no further oxidation of the solder because of the vacuum conditions. Oxidation of the solder could potentially hamper the re-melting of the solder into one “film” on top of the hole. However, because of the vacuum condition when the solder is re-melted, there is no need to use a soldering flux since oxidation will not be present in a vacuum.

As an alternative, before “re-soldering” the solder film, the package can be backfilled with dry nitrogen, carbon dioxide or any noble gas.

After the step of re-melting the solder, the solder “film” is protected by an epoxy, preferably an ultraviolet activated epoxy, to make the solder seal more robust in extreme environments such as defense, security and aerospace environments.

This method of sealing advantageously provides low cost, a small form factor product and this method is compatible with mass production methods. There would no longer be a need to draw a vacuum through annealed copper tubing connected to a vacuum system after which the tubing is “pinched off” to seal the package or to draw a vacuum through a glass tube connected to a vacuum system after which the glass tube is melted to seal the package. Thus a package according to the present method would be smaller than a package with a “pinched off” copper tube.

Furthermore, using this method, a package can be completely formed including sealing the lid (often a glass lid) before the vacuum is sealed and the “solder hole” closed by re-melting solder according to the present method. Therefore, this method imposes fewer constraints on the processes used to seal the lid. Using this method, the seal of the package can be tested before the final solder film is re-melted and sealed.

Additionally, when a package is returned from “the field” for repair, the vacuum may be released, the lid opened, and internal devices either repaired or replaced. Then, the lid is reattached, a new vacuum drawn and the package sealed through the same “solder hole sealed according to this method.

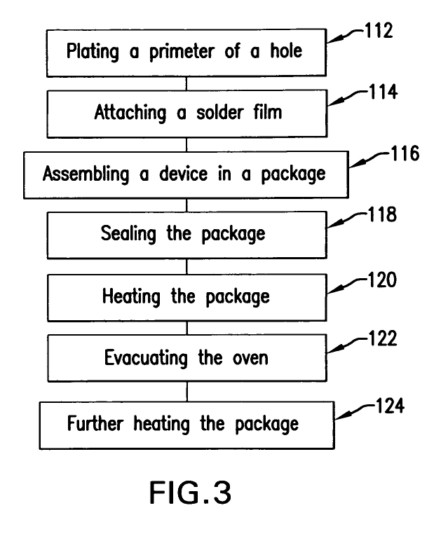

In FIG. 3, a method of packaging device 20 (see FIG. 1A) in package 10 (see FIG. 1A) includes forming a hole in the package, plating a perimeter of the hole at step 112 and attaching solder film 12 (see FIG. 1A) to the plated perimeter at step 114. The solder film covers the hole. The method further includes assembling device 20 (see FIG. 1A) in package 10 (see FIG. 1A) at step 116 and sealing the package to define an interior and an outside at step 118. The device is contained within the interior. Next the method includes heating the assembled package in vacuum oven 40 (see FIG. 2) at step 120 to a predetermined temperature where solder film 12 (see FIG. 1A) bonds to the plated perimeter, evacuating the vacuum oven at step 122 to form a vacuum until the solder film fractures as a gas contained in the interior escapes to the outside, and further heating the assembled package at step 124 in the vacuum oven after the gas in the interior escapes to the outside and until the solder film re-melts and seals over the hole.

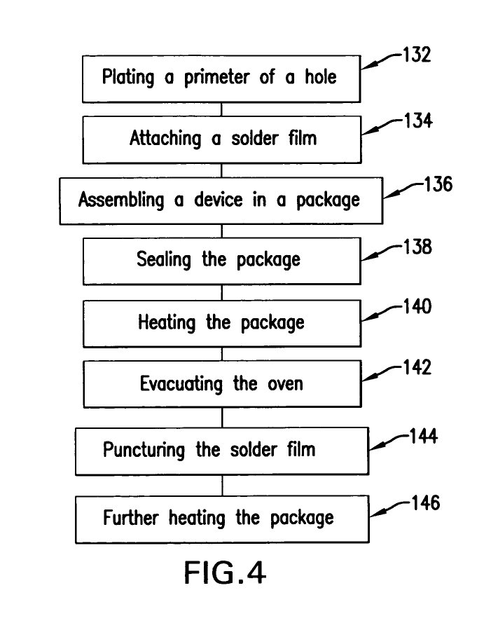

In FIG. 4, a method of packaging device 20 (see FIG. 1 A) in package 10 (see FIG. 1A) includes forming a hole in the package, plating a perimeter of the hole at step 132 and attaching solder film 12 (see FIG. 1A) to the plated perimeter at step 134. The solder film covers the hole. The method further includes assembling device 20 (see FIG. 1A) in package 10 (see FIG. 1A) at step 136 and sealing the package to define an interior and an outside at step 138. The device is contained within the interior. Next, the method includes heating the assembled package in vacuum oven 40 (see FIG. 2) at step 140 to a predetermined temperature where solder film 12 (see FIG. 1A) bonds to the plated perimeter, evacuating the vacuum oven at step 142 to form a vacuum, puncturing the solder film at step 144 with a needle so that a gas contained in the interior escapes to the outside, and further heating the assembled package at step 146 in the vacuum oven after the gas in the interior escapes to the outside and until the solder film re-melts and seals over the hole.

As depicted in FIG. 2, this method is compatible with batch sealing.

To set up the batch sealing, windows are formed in simple fixtures in the normal environment where the package perimeters of the packaged devices are aligned with respect to the windows. Any kind of compression, ultrasonic, diffusion-bonding and soldering techniques are now easily performed as these are atmospheric bonding processes. Then after sealing by re-melting solder, the solder film forms a good hermetic barrier.

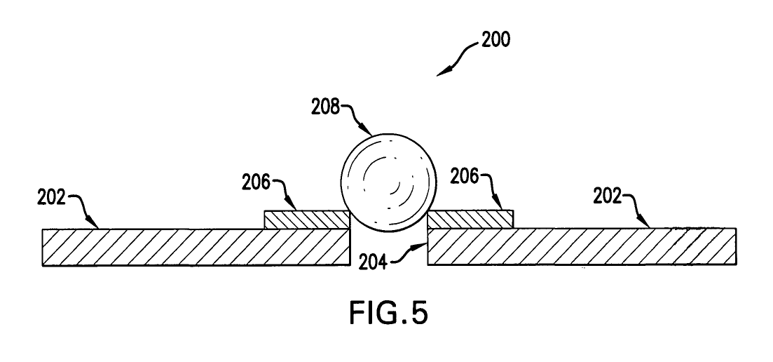

As depicted in FIG. 5, an alternative sealing arrangement 200 includes a hole 204 formed in a wall 202 of a package where a perimeter surrounding the hole 204 is plated with material 206 that bonds well to solder and forms a solder plated hole. A solder ball 208, slightly larger than hole 204, is placed on the plated material 206. After placing solder ball 208 centered in the plated hole, the vacuum oven 40 (see FIG. 2) is evacuated so solder ball 208 lifts up like a valve flap as gases leave the package cavity and solder ball 208 remains present on top of the plated hole while the package cavity evacuates to the same vacuum level as the vacuum oven. After the package cavity is evacuated of gases, temperature of the vacuum oven is raised until solder ball 208 melts and creates a barrier and seal over plated hole 204. The exact dimensions, thickness, etc. of the materials are balanced to provide a reliable solid seal over hole 204. Solder ball 208, usually about 0.8 mm in diameter, can be made of any material good for soldering. For example, solder ball 208 may be made of a polymer core ball, an SAC solder ball, lead solder ball, etc. The heavier the solder ball is, the easier it is for gravity to hold the solder ball in hole 204 until it is melted and secured to the surface of plated material ring 206. Simplest way to attach the solder ball is to just lay the solder ball on top of the hole and raise the temperature.

Alternatively, the hole can be enlarged at the top into a small cavity or taper so the solder ball will sit lower in the hole, but not fall through. The surface of the hole cavity in contact with the solder ball should be plated with material 206 which may be easily soldered. Then, solder ball 208 rests deep inside the small cavity of the hole to keep it from falling or rolling off the surface due to gravity and air flow caused by the vacuum oven when evacuated. Eventually, a raising temperature will transform the solder ball into a closed barrier.

Having described preferred embodiments of a novel technique for creating vacuum sealed packages (which are intended to be illustrative and not limiting), it is noted that modifications and variations can be made by persons skilled in the art in light of the above teachings. It is therefore to be understood that changes may be made in the particular embodiments of the invention disclosed which are within the scope of the invention as defined by the appended claims.

Having thus described the invention with the details and particularity required by the patent laws, what is claimed and desired protected by Letters Patent is set forth in the appended claims.

What is claimed is:

1. A method comprising:
plating a perimeter of a hole formed in a package;
attaching a solder film to the plated perimeter, the solder film covering the hole;
assembling a device in the package;
sealing the package to define an interior and an outside, the device being contained within the interior;
heating the assembled package in a vacuum oven to a predetermined temperature where the solder film bonds to the plated perimeter;
evacuating the vacuum oven to form a vacuum until the solder film fractures as a gas contained in the interior escapes to the outside; and
further heating the assembled package in the vacuum oven after the gas in the interior escapes to the outside and until the solder film re-melts and seals over the hole.

2. A method according to claim 1, wherein the assembling of the device in the package includes:
attaching a device to the package;
wire bonding device pads to package pins; and
sealing a lid to the package.

3. A method comprising:
plating a perimeter of a hole formed in a package;
attaching a solder film to the plated perimeter, the solder film covering the hole;
assembling a device in the package;
sealing the package to define an interior and an outside, the device being contained within the interior;
heating the assembled package in a vacuum oven to a predetermined temperature where the solder film bonds to the plated perimeter;
evacuating the vacuum oven;
puncturing the solder film with a needle so that a gas contained in the interior escapes to the outside; and
further heating the assembled package in the vacuum oven after the gas in the interior escapes to the outside and until the solder film re-melts and seals over the hole.

4. A method according to claim 3, wherein the assembling of the device in the package includes:
attaching a device to the package;
wire bonding device pads to package pins; and
sealing a lid to the package.

5. A packaged device comprising:
a package having a hole formed therein, a perimeter of the hole being plated;
a solder film attached to the plated perimeter of the hole;
a device assembled within the package; and
a lid attached to the package,
wherein the package, the lid and the solder film cooperate to enclose an evacuated vacuum chamber in which the device is contained.

6. A method comprising:
placing a plurality of packaged devices in a vacuum oven in which has been installed a spring and a windbag containing quantity of gas, a plate being affixed to the windbag;
evacuating the vacuum oven so that the gas in the windbag expands to urge the plate toward the plurality of packaged devices, the spring being compressed as the gas expands so as to urge the plate away from the plurality of packaged devices;
puncturing a solder film seal in each of the plurality of packaged devices with needles mounted on the plate after the plate has moved a predetermined distance toward the plurality of packaged devices, the puncturing of the solder film seal permitting gas within each of the plurality of packaged devices to escape into the vacuum oven from which the gas is evacuated;
opening a valve between an interior of the windbag and the vacuum oven after the plate has moved the predetermined distance, the opening of the valve permitting the gas in the windbag to escape into the vacuum oven from which the gas is evacuated, the spring urging the plate to retract away from the plurality of packaged devices after the gas in the windbag escapes into the vacuum oven; and
heating the plurality of packaged devices in the vacuum oven after the gas within each of the plurality of packaged devices has escaped into the vacuum oven, the heating being sufficient to re-melt the solder film seal and seal over a hole produced by the puncturing.
